(19) United States
(12) Patent Application Publication
(10) Pub. No.: US 2005/0097792 A1
(43) Pub. Date: May 12, 2005

(54) Apparatus and method for simulation of combustion effects in a fireplace

(76) Inventor: Damir Naden, Oakville (CA)

Correspondence Address: CHARLES C. VALAUSKAS;BANIAK PINE & GANNON, Suite 1200, 150 N. Wacker Drive, Chicago, IL, 60606, US

(21) Appl. No.: 10/703,801

(22) Filed: Nov. 6, 2003

(51) Int. Cl. G09F 19/00

(52) U.S. Cl. 40/428

(57) ABSTRACT

The present invention produces a combustion simulation of flames, burning logs and embers in a fuel-burning fireplace or like device. One or more light source(s), such as LEDs, are used to transmit light to and through: a flame cut-out panel or flame cut-out mask to simulate the flame effect; cut-outs in logs to simulate a burning edge of a log; elements or refractories that refract the light to simulate real burning embers. Fiber optic cables, or any other material that facilitates the transmission of light, may be used to assist in transmitting the visible light. A motor driven rotating disk that includes apertures may be used to fragment the transmission of the visible light. In addition, the light source may be controlled by a sequencing device to closely approximate the pulsing intensities of light seen in actual flames, the edges of burning logs, and ember beds.

### FIELD OF THE INVENTION

The present invention relates generally to electric fireplace technology. In particular, the present invention relates to an apparatus and methods that provide improved simulation of combustion effects in a fireplace through illumination.

### BACKGROUND OF THE INVENTION

Fireplaces are desirable features in the home. Traditional wood or other solid fuel burning fireplaces have, however, gradually become replaced by devices that burn non-solid materials, such as gas, or that produce heat electronically. The combustion of gas does provide real flames and heat. However, depending on the geographical region in which the fireplace is used, gas may be an expensive source of energy. Gas combustion also requires a working flue to vent the combustion products.

Electric or electronic fireplaces are a clean and easy source of heat. Electric fireplaces may be installed in locations often for less expense and where gas fireplaces are not desired or will not fit. However, electric fireplaces do not have the same combustion effects that are produced by fuel burning fireplaces. To overcome this shortcoming, electric fireplace designs have been developed with devices that operate to simulate the flame or fire associated with fuel burning fireplaces. Some electric fireplaces provide a reasonably realistic simulation of a wood-burning fireplace. Electric fireplaces may include simulated burning logs and simulated embers that add to the impression of a wood fire. Various mechanisms have been provided to add moving and/or flickering flames. The success of the simulation depends on the skill of the manufacturer to provide various mechanisms to manipulate combinations of lights, screens, and filters and to provide a random and lifelike flame, burning logs, and ember effect.

A number of these simulated fire devices which provide a visual imitation of natural flames, burning logs and ember bed characteristics of a fire, by way of a simulated effect, have previously been proposed with varying degrees of success. In general, these efforts have produced devices that are complex, multi-component arrangements that are time-consuming and expensive to manufacture. Also, the flame, burning logs and ember bed effect simulated by the devices has been generally limited in scope. With time, consumers find the simulation unconvincing representations of actual combustion effects.

Specifically with respect to electric fireplaces, the flame effect has been generated using very similar techniques for decades. For example, the flame effect in certain embodiments is produced using pieces of light weight fabric such as silk, which is cut into flame-like shapes. A blower creates air flow which in turn moves the fabric to imitate the flame. Another embodiment utilizes a light randomizer, such as aluminum foil pieces, that is rotated in front of a standard light bulb. The light is reflected over the randomized piece, projected through a mask of flame shape cut-outs and onto a screen. Drawbacks include unrealistic flame appearance and repetition of the flame simulation over a short period of time. An additional disadvantage is that the effect relies on the use of a motor to rotate the light randomizer. The life of the effect, therefore, turns on the life of the motor. Also, the life of a standard light bulb is short and therefore must be frequently replaced.

Electric fireplaces of various designs have been suggested that provide a simulated ember bed effect. For example, U.S. Pat. No. 6,162,047 transmits light from a light bulb through a sheet of plastic (or similar) material which has been formed into a grating of transparent, translucent and opaque sections. The transmitted light illuminates the underside of the partially transparent plastic sheet to simulate an ember bed effect. In order to create a flicker-like effect to the ember bed simulation, motor driven rotating pieces of reflective foil generate first or second reflections of the light source. This approach is complicated since it is highly dependent upon accurate placement of many reflecting surfaces. Additionally, overall image quality varies as a viewer moves around the room. An additional drawback of this method is that the embers glow unrealistically since real glowing embers tend to pulse in intensity—from low to high intensity—depending on the air flow around them.

There is a demand, therefore, for a simple and cost-effective assembly that accurately and realistically simulates the flame or fire that is produced from the combustion of logs or other combustible fuel source and that can be used in electric or gas burning fireplaces. The present invention satisfies that demand.

### SUMMARY OF THE INVENTION

The present invention has a principal objective of providing a realistic simulation of that which occurs as a result of the combustion of combustible materials in a fuel-burning fireplace or like device. The combustible material that is simulated in the present invention may be, for example, logs. The result of the combustion that is simulated in the present invention may include the flames, the burning logs, and the embers. The assemblies of the present invention may, and in most embodiments will include some type of housing on or in which the present invention is located and operates.

The housing of the present invention may take any suitable form as needed or desired and may be in the form of an enclosure or framework, sized and shaped according to a number of considerations. Examples of these considerations include budget, space, aesthetic, mechanical, safety, and other design and operating considerations. Generally, the housing is an enclosure or structure in which or to which mechanisms and components, such as ember bed simulation assembly, logs, and flame simulation unit, are enclosed or attached. The housing is also that which is attached at an installation location. The housing or box may be manufactured from a wide variety of materials, including plastic resin suitable for the application, sheet metal, or any other material known to those skilled in the art.

A fire display box is positioned in the housing. For purposes of this application, the term “fire display box” will broadly signify the area similar to that which is found in a fuel-burning fireplace in which combustion takes place and from which the fire that is produced thereby may be viewed. Traditionally, this area is known as a “firebox,” “box,” or “fireplace.”

One embodiment of the housing includes a top panel, a bottom panel, a back panel and opposing side panels. The two opposing side panels are further optional depending on the application. The housing of this embodiment is sized and shaped to accommodate a fire display box positioned therein. The fire display box is designed to present to a viewer the impression of a working, more traditional non-electronic fireplace. The fire display box is open to the front for viewing purposes and may optionally be provided with a fixed or movable front panel, which may be at least in part transparent, translucent or opaque. For purposes of this application, the front of the fireplace unit is that side of the unit through which the interior of the unit is at least partially viewable. Certain elements of the present invention are located within the fire display box.

The combustion simulation of the present invention may include elements that simulate the flames produced from the combustion of combustible materials. One embodiment of a unit with flame simulation capabilities includes a projection screen visible to the viewer, in the viewing area, or front of the fire display box. At least one light source, or light illumination source, as well as a flame cut-out panel or flame cut-out mask may be contained within the fire display box to simulate the flame effect. In certain embodiments, the flame cut-out panel is located between the projection screen and the light illumination source. The flame cut-out panel may include a number of individual cut-outs, the shape of each of which is roughly the shape of individual stylized flames, varying in size, shape, and/or form.

Another embodiment of flame simulation assembly includes a plurality of light sources and a mask with a plurality of cut-outs. Each light source may be positionable relative to the mask cut-outs to vary the combustion effect. To illustrate, each cut-out on the mask may be situated approximately in front of an individual light source to produce a more intense combustion effect. A light source offset from the mask cut-out produces a less intense combustion effect. Overall, the number of individual light sources and the number of flame cut-outs on the flame cut-out panel may depend on the size of the fire to be replicated. For example, six light sources are required if six individual flame cut-outs are on the flame cut-out panel. The position of the light illumination source(s) is not obvious to the viewer since it is positioned behind the flame cut-out panel.

An additional embodiment includes a screen or privacy glass panel, made of material that has a property of changing the opacity according to the electric current applied to it. The privacy glass panel has a high degree of transparency when electrical current is applied. A controller applies electrical current to the privacy glass when the fireplace is turned off. This allows the user to see through this glass and have the visual perception of the logs and ember bed when the fireplace is off. The privacy glass is cloudy or hazy when no electrical current is applied. A controller prevents the flow of electrical current to the privacy glass when the fireplace is turned on. The privacy glass can be positioned anywhere inside the fireplace—such as inside the ember-bed or imitation logs—because it is nearly invisible to the user when the fireplace unit is off.

More specifically, the privacy glass may be made from clear or tinted glass or a glass-like polymeric-based material, such as polycarbonates, through the use of which image of flickering flames is produced that is well defined and realistic. The material used for the privacy glass can be free-forming so that the glass can be manipulated into any shape desired. For example, forming the privacy glass to a three-dimensional shape can create the look of a flame that would appear to be coming from different planes within the ember-bed and/or logs, greatly improving the realism of the fire effect in the electric fireplaces.

An embodiment of the flame simulation assembly may include simulated logs with portions that appear to be undergoing or that had recently underwent combustion. The logs, for example, can be made from ceramic, Styrofoam or any other material that can be made to resemble a wood surface. The simulated logs may include combustion portions that are sized, shaped, and colored, and/or that facilitate illumination to simulate a log or logs in the process of combustion. For example, in this embodiment, the simulated logs may include an opening or openings with centered “cut-outs” defined by log edges that—due to size, shape and color—have the appearance of burning just as the burning edge of a real log in a real wood fireplace that is in the process of being combusted. Light may be transmitted from one or more light source(s) to and through the cut-outs in the log.

The combustion simulation may comprise or include a simulation of an ember bed. The ember bed simulation of the present invention is constructed from a suitable material such that the size, shape, texture, and/or color of an ember bed of a conventional wood burning fireplace is simulated. The ember bed simulation is positioned preferably on the bottom panel of the fire display box. To assist in the simulation of the ember bed, a light source may be positioned within or adjacent to the fire display box to provide illumination. To further assist in the simulation of an ember bed, the light source may be positioned such that at least a portion of the light passes through an element or elements that refract the light. The element or elements that refract light for purposes of this application shall be termed “refractories”. The refractories may be positioned within the simulated ember bed and juxtaposed relative to the simulated fire elements and burn patterns to give a look closely resembling real embers burning in a wood fireplace.

One embodiment of the refractories includes a surface having at least one face on the surface, to allow refraction of light in more than one direction. This allows the simulation of a glowing ember bed effect to be viewed from more than one angle from the front of the fireplace. The refractories may include a surface having a plurality of faces positioned around the surface so that light is refracted in a multiple of directions thereby assisting in the ember bed simulation. The refractories may be one single multifaceted bead or a plurality of beads to realistically replicate real bed embers. Refractories that are suitable for this purpose include multifaceted beads made from plastic, glass, or a naturally occurring material; broken pieces of tempered glass; and broken pieces of plastic such as acrylic or polycarbonate may be used as refractories. The refractories may be clear or colored including those that are, for example painted with stained glass paint.

One embodiment of the ember bed simulation includes multiple light sources positioned generally adjacent to and underneath the refractories on the ember bed. The position of any one of the light sources preferably facilitates the approximation of the overall size and shape of a real ember bed but is not apparent to one observing the simulation.

Another preferred embodiment of the present invention uses light emitting diodes, termed LEDs for purposes of this application. A light emitting diode is any semiconductor device that emits visible light when an electric current is passed through it. LEDs can be of varying type such as air gap LEDs, GaAs LEDs and polymer LEDs. LEDs are high intensity, energy efficient illumination sources. LEDs, either individually or custom packaged, are commercially available from manufacturers, among others, such as Boca Flasher, Boca Raton, Fla. LEDs produce light in many colors, including, but not limited to, amber, yellow, orange, green, blue and white—further, an individual LED may be designed to change colors, varying from amber to yellow to orange, in response to an electrical signal. LEDs give off virtually no heat and have a relatively unlimited lifetime, essentially eliminating the need for replacement. The LEDs may comprise a plurality, or cluster, of LEDs. Alternatively, the LEDs may comprise one individual LED. Again, the intensity of the light source may be varied such as by varying the location and/or number of LEDs. Further, the LEDs can include a textured surface to provide “diffused light”. “Sandblasting” provides such a textured surface.

Illumination in other embodiments of the present invention may be provided by one or more long-life halogen light bulbs, incandescent light bulbs, flame based sources, carbon arc radiation sources, fluorescent sources, luminescent bulbs or induction light bulbs. Fiber optic cables, or any other material that facilitates the transmission of light, such as acrylic or nylon, may be used to assist in transmitting the visible light.

Fiber optic cables are long, thin strands of very pure glass arranged in bundles to transmit light signals over long distances. The fiber optic cables guide the light from the light source(s) to the area to be illuminated. The core of a fiber optic cable consists of a thin glass center. The light in a fiber optic cable travels through the core by constantly bouncing from the cladding, or mirror-lined walls, a principle called total internal reflection. The cladding is an outer optical material surrounding the core that reflects the light back into the core. Because the cladding does not absorb any light from the core, the light wave can travel great distances. In embodiments that include fiber optic cable, one end of the cable is positioned generally adjacent to the light source and another end is positioned generally adjacent to the flame cut-out panel or log burning edge of the flame simulation or to the refractories of the ember bed simulation.

In addition to the fiber optic cables, polymer-based cables of high clarity may also be used to transmit the visible light.

Further, as an additional embodiment, a motor driven rotating disk can be positioned between one or more light sources and one or more fiber optic cable ends. The disk includes apertures, which approximate a series of shutters that fragment the transmission of the visible light as the disk rotates thereby causing the light emitted from the light source to interruptedly enter the fiber optic cable. By varying the number and location of the apertures in the disk, light of varying brightness may be transmitted through the fiber optic cable and therefrom to the flame cut-out panel, logs or refractories. The combustion simulation as a result takes on an undulating effect like that seen in fireplaces in which wood is actually burning.

The light source may be controlled by a sequencing device, or sequencer, that is able to produce light effects, for example, timing, flashing, repetition, color changes, brightness changes and the like. The sequencing device of the preferred embodiment includes a printed circuit board with a microprocessor that is electrically connected to the light source. The microprocessor is programmable to provide electrical signals to one, a group of, or all of the LEDs. The programmed control can be manipulated so as to closely approximate the pulsing intensities of light seen in actual flames, the edges of burning logs, and ember beds. The program of the sequencer can be changed to vary the flame, log burning edge, and ember bed effect. For example, beyond factory programming, instructions can be transmitted via the internet in order to vary the combustion simulation effect or effects.

These and other advantages, as well as the invention itself, will become apparent in the details of construction and operation as more fully described and claimed below. Moreover, it should be appreciated that several aspects of the invention can be used in other applications where realistic (flame and ember bed) simulations would be desirable.

### BRIEF DESCRIPTION OF THE DRAWINGS

FIG. 1 is a diagrammatic front view of an electric fireplace illustrating the present invention in use;

FIG. 2 is a combustion simulation assembly that simulates flames according to one embodiment of the present invention;

FIG. 3 is a combustion simulation assembly that simulates flames according to an alternate embodiment of the present invention;

FIG. 4 is a combustion simulation assembly that simulates the burning edges of combustion material according to an alternate embodiment of the present invention;

FIG. 5 is a combustion simulation assembly that simulates an ember bed according to one embodiment of the present invention; and

FIG. 6 is a combustion simulation assembly that simulates an ember bed according to an alternate embodiment of the present invention.

### DETAILED DESCRIPTION OF A PRESENTLY PREFERRED EMBODIMENT

The present invention will now be described in detail with reference to certain embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well-known process steps and/or structures have not been described in detail to prevent unnecessarily obscuring the present invention.

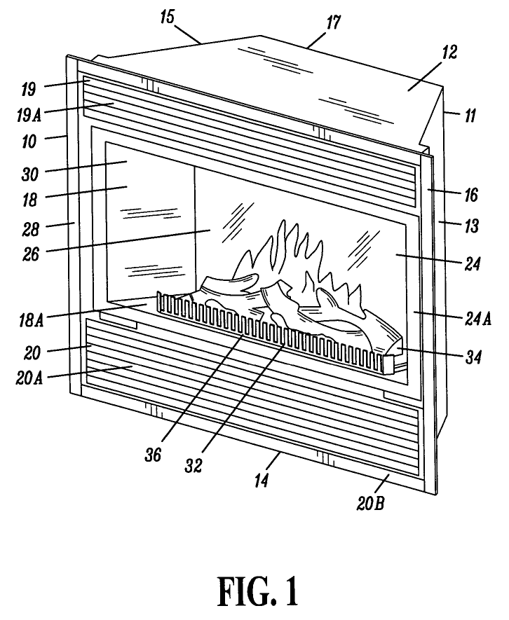

The present invention is used as an electric fireplace 10. The assembly of one type of electric fireplace 10 that is the subject of the present invention is illustrated in FIG. 1. This embodiment of fireplace 10 includes a housing 11 having a top panel 12, a bottom panel 14, two opposing side panels 13 and 15, a front side 16, and a back panel 17 that collectively generally define an interior 18. Other embodiments of an electric fireplace 10 may include various shaped panels, brackets, rods, bulkheads, rails, posts, and so on (no specifically shown). The housing 11 of the embodiment shown in FIG. 1 is of any suitable form or material sufficient to provide for installation, support, insulation, and/or aesthetic considerations of the fireplace 10. For example, one suitable material from which the housing 11 may be manufactured is sheet metal. The sheet metal is cut, bent and joined to form the structure of the housing 11. In the preferred embodiment shown in FIG. 1, the back panel 17 and two opposing side panels 13 and 15 are cut from a single piece of sheet metal and bent into shape. The combined back panel 17 and side panels 13 and 15 of the housing are commonly referred to as the fireplace wrapper. The top panel 12 and bottom panel 14 each may be attached to the upper and lower edges of the back panel 17 and side panels 13 and 15 (i.e., the fireplace wrapper) to complete the basic structure of the housing 11. The edges of the individual side panels 13, 15 are typically bent to provide a small overlap at the juncture of adjoining panels. The metal panels are then joined together by suitable fasteners such as sheet metal screws or by other methods such as by welding.

It will be understood that the present invention may be effectively used where desired in conjunction with heat-producing and non-heat-producing electric fireplaces as well as other similar types of mechanisms, enclosures or products. The present illustrated embodiment is directed to an electric fireplace having features that actually function to enable the use of heat-producing mechanisms, such as an electric blower, or simulate the capability of a fireplace with such a heat-producing mechanism. Of course, the simulated flame assembly of the present invention may be used in a product which does not include all or any of these mechanisms or features, some of which are discussed below.

The upper portion 16A of the front side 16 of the electric fireplace 10 illustrated in FIG. 1 includes an upper louver panel 19 having a series of spaced horizontal slats or louvers 19A. Slats 19A are spaced apart to allow room air to pass in through upper louver panel 19 and subsequently be expelled back into the room. Slats 19A of upper louver panel 19 are angled upwardly from front to back in such a manner as to prevent someone who is standing in front of the electric fireplace from seeing through upper louver panel 19. Upper louver panel 19 may be made removable to permit access to the interior of housing 11 in the event that maintenance or repair is necessary.

The lower portion 16B of front side 16 of electric fireplace 10 illustrated in FIG. 1 comprises a lower louver panel 20 similar in design and configuration as that of upper louver panel 19. In other words, lower louver panel 20 is comprised of a series of horizontal slats or louvers 20A that are spaced and angled in a similar fashion as slats 19A of upper louver panel 19. Lower louver panel 20 may be sized and shaped to conceal any switches (not shown) and other devices that control the operation of electric fireplace 10. In the preferred embodiment, the bottom edge 20B of lower louver panel 20 is connected to bottom panel 14 of housing 11 with one or more hinges or similar devices (not shown) that permit lower louver panel 20 to be folded outwardly and downwardly to gain access to any electric fireplace controls (not shown). The hinges may contain springs that bias lower louver panel 20 in a vertical or closed position.

The upper and lower louver panels, 19 and 20, may be also designed and configured to simulate a concealed heat exchanger plenum arrangement of the type often incorporated in combustible fuel-burning fireplaces (not shown). For example, natural gas fireplaces often have a series of interconnected plenums surrounding the fire display box that form a convection air passage around the fire display box. Room air is typically drawn into and expelled out from the plenum arrangement by passing through louver panels above and below the fire display box. Louver panels 19, 20 of the preferred embodiment are designed and configured to suggest the presence of a heat exchange plenum arrangement, thereby increasing the realism of the electric fireplace.

Front side 16 of electric fireplace 10 may include a viewing portion 24 through which portions of interior 18 may be viewed. Viewing portion 24 may be in the form of a panel 24A (as shown) or, in the alternate, be translucent or an opaque door, which, for purposes of viewing the interior 18, may be opened. Depending on the desired aesthetic appearance, the fireplace viewing portion 24 may be either clear, tinted, or a privacy glass panel that has a property of changing the opacity according to the electric current applied to it. Tinting of viewing portion 24 may increase the realism of the fireplace by inhibiting the viewer's ability to discern the components used to create the illusion of a real wood-burning fire. In the preferred embodiment shown, viewing portion 24 is clear glass. Any transparent material can be utilized for viewing portion 24. For example, clear or tinted acrylic could be used in lieu of glass or a glass-like polymeric-based material, such as polycarbonates. Viewing portion 24 in the embodiment illustrated in FIG. 1 is positioned between upper and lower louver panels, 19 and 20, and permits viewing of the simulated fire display box 26. However, privacy glass can be positioned anywhere inside the fireplace, for example inside the ember-bed or imitation logs. Viewing portion 24 may be supported by a frame 28 and includes hardware (not shown) of the same type as or a version of which is ordered to simulate a glass door assembly of the type typically used to enclose the fire display box of a combustible fuel-burning fireplace. Viewing portion 24 with or without frame 28 is moveable or is removable to permit cleaning, maintenance or repair of components within a fire display box 26.

Fire display box 26 is provided within housing 11 or formed variously from components of housing 11. As will be discussed in greater detail below, fire display box 26 supports various components of electric fireplace 10. A fire display box surface 30 is typically used to line the fire display box of combustible fuel-burning fireplaces and may be painted to appear like firebrick. Alternatively, ceramic fiber refractory panels (not shown)—that have been shaped and colored to look like firebrick—can be attached to the interior surface of housing 11 to form a realistic appearing fire display box 26. The manufacturing process for vacuum forming and coloring ceramic fiber refractory panels is well known in the art. Other materials can also be used to manufacture the artificial refractory panels.

Within the lower portion 18A of fire display box 26, an artificial log and ember set 32 is positionable. Log and ember set 32 in the embodiment illustrated in FIG. 1 comprises one or more artificial logs 34 supported by an artificial ember bed 36. Artificial logs 34 are shaped and colored to simulate the appearance of actual logs of any type. Ember bed 36 is shaped and colored to simulate the appearance of burnt portions from a log and/or burning coals or embers. Artificial logs 34, as well as ember bed 36, may be molded from ceramic fiber by a vacuum forming process that is well known in the art.

Other materials may also be used to manufacture artificial logs 34 and ember bed 36. For example, these components may be molded from concrete, which provides for greater detail than can be achieved by using ceramic fiber. However, concrete is much heavier and is prone to breakage if accidentally dropped. The artificial logs 34 and embers 36 can also be made from other materials such as plastic. However, forms of plastic often do not provide as realistic of an appearance as does ceramic fiber or concrete.

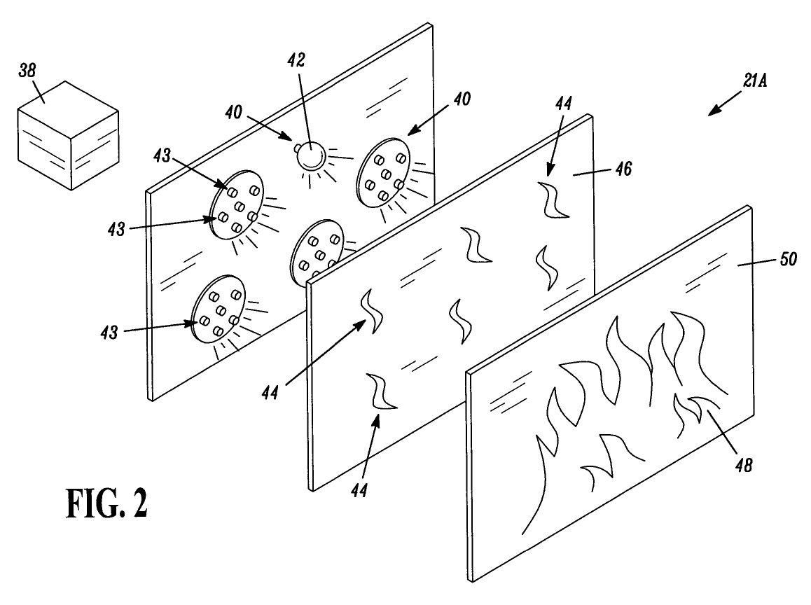

FIG. 2 shows a combustion simulation assembly 21A according to one embodiment of the present invention that simulates the flames produced during the course of combustion. A sequencing device 38, termed “sequencer”, provides electrical signals (not shown) to a light source 40 by means of electrical connections, for example a simple wire, or using more sophisticated “bus” technologies. While light source 40 may be a single source 42, light source 40 shown in the FIG. 2 embodiment includes a plurality of LEDs 43. The electrical signals produced by sequencer 38 control various aspects of light source 40, such as which of the individual LEDs 43 of light source 40 are ‘on’ or ‘off’, the duration each individual LED 43 is ‘on’ or ‘off’, and the quantity of LEDs 43 that are made available to be ‘on’ or ‘off’. Upon receiving an ‘on’ electrical signal from sequencer 38, light source 40 emits light from LEDs 43. The light emitted from LEDs 43 may pass through a number of individual flame cut-outs 44, the shape of which may be roughly the shape of individual stylized flames, varying in both size and shape, or form, formed in a flame cut-out panel 46. Each individual light source 40 is placed generally adjacent to cut-out panel 46 so as to facilitate the production of a simulated flame effect 48. In the FIG. 2 embodiment, each cut-out 44 formed in cut-out panel 46 is situated approximately in front of an individual light source 40.

After the light from LEDs 43 passes through flame cut-outs 44 in the FIG. 2 embodiment, it is projected as flame effect 48 on a projection screen 50. Projection screen 50 is positioned within interior 18 of housing 11 so as to be visible to a viewer from front side 16 of fire display box 26. Within fire display box 26, flame cut-out panel 46 is positioned between light source 40 and projection screen 50.

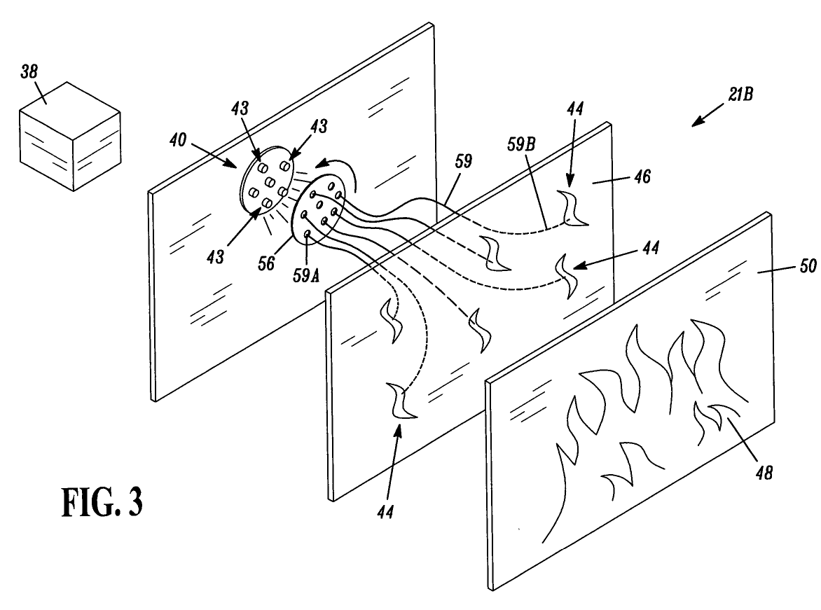

FIG. 3 is a combustion simulation assembly 21B according to an alternate embodiment of the present invention that simulates the flames produced during the course of combustion. As with the FIG. 2 embodiment, sequencer 38 provides electrical signals to light source 40. Light source 40 is a single light source 43, such as a single LED, long-life halogen light bulb, incandescent light bulb, flame based sources, carbon arc radiation sources, fluorescent sources, luminescent bulb or induction light bulb. Upon receiving the electrical signals from sequencer 38, light source 40 is able to emit light. Again, the electrical signals of sequencer 38 control various aspects of light source 40. In the embodiment illustrated in FIG. 3, the light emitted from light source 40 may pass through one or more of fiber optic cables 59. In the embodiment shown, each of fiber optic cables 59 have a first cable end 59A and a second cable end 59B, first cable end 59A positioned adjacent to light source 40, and second cable end 59B positioned adjacent to each cut-out 44 formed in flame cut-out panel 46. Thus, fiber optic cables 59 are routed between light source 40 and flame cut-out panel 46.

After the light from light source 40 passes through flame cut-outs 44 via fiber optic cables 59, flame effect 48 is projected on screen 50. Projection screen 50 is positioned within interior 18 of housing 11 so as to be visible to a viewer from front side 16 of fire display box 26. Within fire display box 26, flame cut-out panel 46 is positioned between light source 40 and projection screen 50.

In reference to the FIG. 3 embodiment, a motor driven rotating disk 56 may be positioned between light source 40 and first end 59A of fiber optic cable 59. Disk 56 may include one or more apertures, each of which may approximate a series of shutters that is able to fragment the light as disk 56 rotates. Thus, the light emitted from light source 40 interruptedly enters fiber optic cable 59, and, by varying the number and location of the apertures in disk 56, light of varying brightness is transmitted through fiber optic cable 59 and therefrom to flame cut-outs 44 in which flame effect 48 is projected on screen 50.

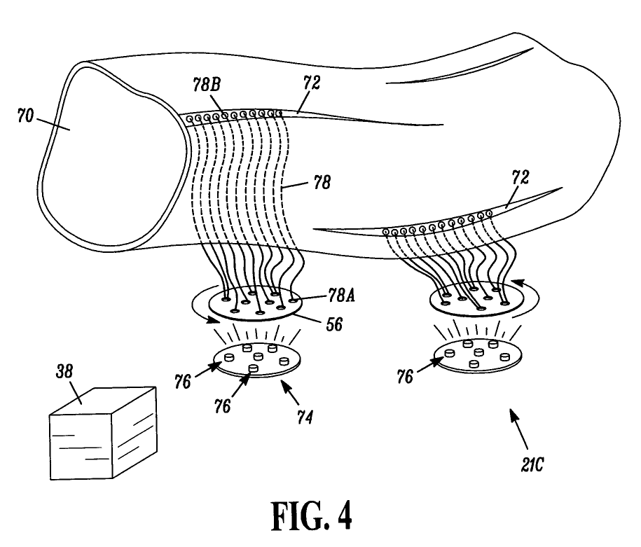

FIG. 4 is a combustion simulation assembly 21C according to an alternate embodiment of the present invention that simulates the flames provided during the course of combustion. Simulation assembly 21C further includes one or more simulated logs 70 with simulated burning edges 72. Logs 70 can be made from ceramic, Styrofoam, or any other material that is sized, shaped, textured, and/or colored to resemble a wood surface. One or more light source 74 is located generally adjacent to and beneath log 70. A sequencer 38 provides electrical signals to light source 74. Sequencer 38 can be programmed in such a way as to produce the effect of the different burning edges 72 producing light from combustion at a different time. Light source 74 may be a single light source—such as a single LED, long-life halogen light bulb, incandescent light bulb, flame based sources, carbon arc radiation sources, fluorescent sources, luminescent bulb or induction light bulb or a plurality of LEDs 76. Upon receiving the electrical signals from sequencer 38, light source 74 is capable of emitting light from LEDs 76. In the illustrated embodiment the light emitted from LEDs 76 passes through burning edge 72 via fiber optic cables 78. Each burning edge 72 may be formed along an edge of or a cut-out within log 70, the cut-out being thin, varying in both length and depth.

The light emitted from light source 74 passes through a number of fiber optic cables 78, each having a first end 78A and a second end 78B. First end 78A of fiber optic cable 78 is adjacent to light source 74. Second end 78B of fiber optic cable 78 is positioned generally adjacent to each edge 72 on the log 70. Thus, fiber optic cables 78 are routed between the light source 74 and edge 72.

In reference to the FIG. 4 embodiment, a motor driven rotating disk 56 may be positioned between light source 74 and first end 78A of fiber optic cable 78. Disk 56 may include one or more apertures, which may approximate a series of shutters that is able to fragment the light as disk 56 rotates. Thus, the light emitted from light source 74 interruptedly enters fiber optic cable 78, through end 78A, and, by varying the number and location of the apertures in disk 56, light of varying brightness is transmitted through fiber optic cable 78 and therefrom to burning edges 72 in log 70, which simulates combustion and the process of same by simulating the burning edges of logs.

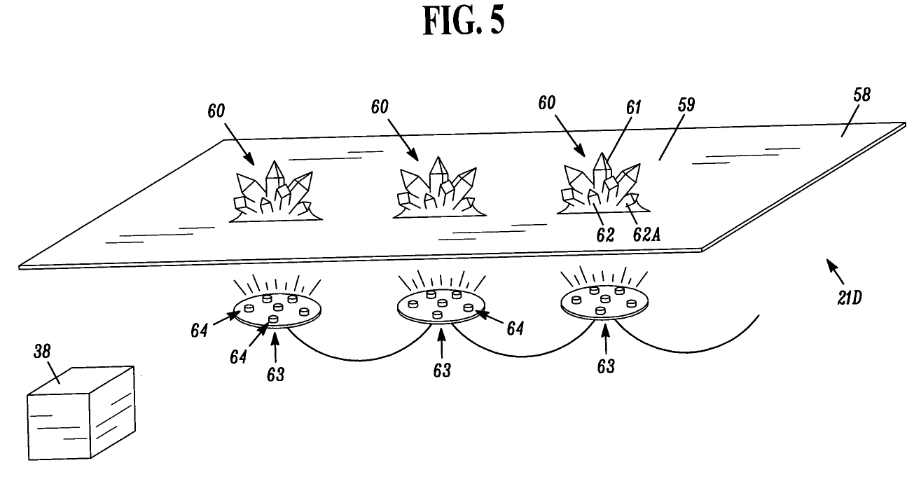

FIG. 5 is a combustion simulation assembly 21D according to another embodiment of the present invention that simulates the embers produced during the course of or as a result of combustion. In the illustrated embodiment, a bed of embers is simulated in the form of an ember bed panel 58 that is positioned and toward bottom panel 14 of fire display box 26 to produce an ember bed effect 59. To further heighten the effect 59, refractories 60 are positioned on ember bed panel 58. Refractories 60 may be a single or multiple refractory elements 61 that are able to refract light transmitted toward and therethrough. A refractory element 61 that includes a surface 62 with multiple facets 62A directs light transmitted through element 61 in a number of multiple directions and provides a viewer with an image that changes as the viewer moves in front of fireplace 10 and observes simulation assembly 21D. A multifaceted bead, beads manufactured with planed multiple facets, or a plurality of beads realistically replicate real bed embers. One or more light sources 63 are positioned within housing 11 and such as underneath refractories 60 on ember bed panel 58. Light source 63 may be one or more LEDs 64. Sequencer device 38 provides electrical signals to light source 63. The electrical signals of sequencer 38 control various aspects of LEDs 64, such as which individual LEDs 64 are ‘on’ or ‘off’, the duration that each individual LED 64 is ‘on’ or ‘off’, and the quantity of LEDs 64 that are ‘on’ or ‘off’. Upon receiving the electrical signals from sequencer 38, light sources 63 emit light from LEDs 64. Refractories 60 are positioned approximately above light sources 63. The light from LEDs 64 passes through refractories 60, which in turn deflect the light in various directions corresponding to the facets on refractories 60. This allows production of a glowing ember bed effect from almost any viewing angle from the front of the fireplace.

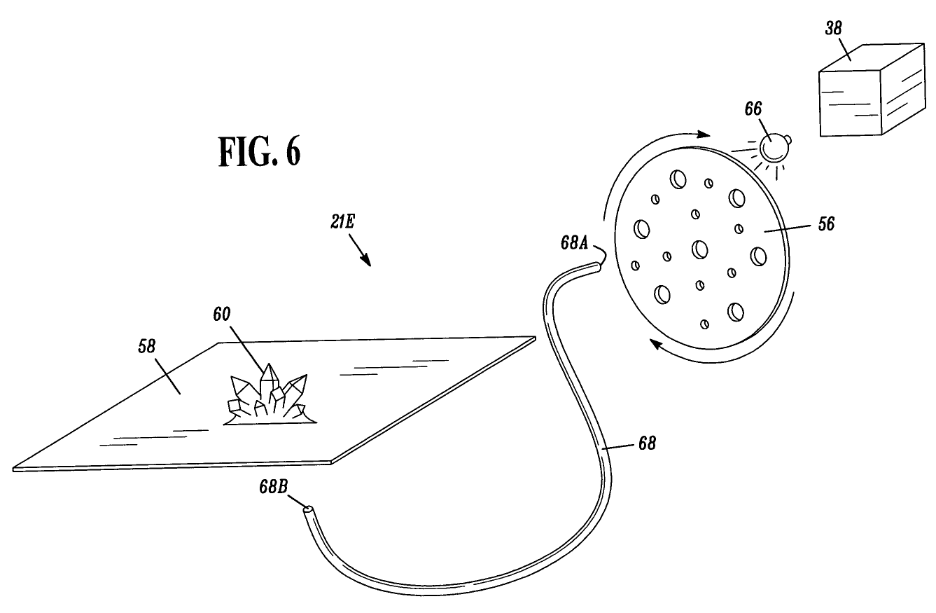

FIG. 6 is a combustion simulation assembly 21E according to an additional embodiment of the present invention that simulates the embers produced during the course of or as a result of combustion. Sequencer 38 may provide electrical signals to a light source 66. In the illustrated embodiment light source 66 is a single light source—such as a single LED, long-life halogen light bulb, incandescent light bulb, flame based sources, carbon arc radiation sources, fluorescent sources, luminescent bulb or induction light bulb. Upon receiving the electrical signals from sequencer 38, light source 66 emits light. Again, the electrical signals of sequencer 38 control various aspects of light source 66. The light emitted from light source 66 passes through a number of fiber optic cables 68. A first end 68A of fiber optic cable 68 is adjacent to light source 66. A second end 68B of fiber optic cable 68 is adjacent to each refractory 60 on ember bed panel 58. Thus, fiber optic cables 68 are routed between light source 66 and ember bed panel 58. As the light is transmitted from light source 66, through fiber optic cables 68, and to refractories 60, ember bed panel 58 realistically replicates real bed embers.

In reference to the embodiment, a motor driven rotating disk 56 may be positioned between light source 66 and first end 68A of fiber optic cable 68. Disk 56 may include one or more apertures, which approximate a series of shutters that fragment the visible light as the disk rotates. Thus the light emitted from light source 66 interruptedly enters fiber optic cable 68, and, by varying the number and location of the apertures in disk 56, light of varying brightness is transmitted through fiber optic cable 68 and therefrom to refractories 60.

Described is an electric fireplace assembly with a combustion simulation arrangement which provides for realistic flame-like and/or ember bed-like effect. While the above-described assembly is intended to be used, in one embodiment with an electric fireplace, it is to be realized that flame and ember bed arrangements according to the invention could be incorporated in other types of heaters or perhaps other decorative arrangements.

Whilst endeavoring in the foregoing specification to draw attention to those features of the invention believed to be of particular importance it should be understood that the Applicants claim protection in respect of any patentable feature or combination of features hereinbefore referred to and/or shown in the drawings whether or not particular emphasis has been placed thereon. While the apparatus and method herein disclosed forms a preferred embodiment of this invention, this invention is not limited to that specific apparatus and method, and changes can be made therein without departing from the scope of this invention, which is defined in the appended claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, failing within the scope of the invention.

1. A flame simulation assembly comprising:
a housing;
a flame cut-out panel;
a light source positioned substantially behind said flame cut-out panel, wherein said light source emits light;
a sequencing device controlling said light emission from said light source; and
a projection screen positioned substantially in front of said flame cut-out panel, wherein said light is transmitted through said flame cut-out panel onto said projection screen.

2. The flame simulation assembly of claim 1 wherein said light source includes a light emitting diode.

3. The flame simulation assembly of claim 1 further comprising fiber optic cables including a first end and a second end, wherein said first end is positioned substantially near said light source and said second end is positioned substantially near said flame cut-out panel.

4. The flame simulation assembly of claim 1 further comprising a rotation disk including apertures positioned substantially near said light source, wherein said rotation disk fragments said light emission from said light source.

5. The flame simulation assembly of claim 1 further comprising a privacy glass, wherein said privacy glass is transparent when electrical current is applied to said privacy glass

6. The flame simulation assembly of claim 6 wherein said privacy glass is opaque when electrical current is not applied to said privacy glass.

7. A flame simulation assembly comprising:
a housing;
a log including an opening; and
a light source positioned substantially beneath said log, wherein said light source emits light through said opening.

8. The flame simulation assembly of claim 8 wherein said light source includes a light emitting diode.

9. The flame simulation assembly of claim 8 further comprising fiber optic cables including a first end and a second end, wherein said first end is positioned substantially near said light source and said second end is positioned substantially near said opening.

10. The flame simulation assembly of claim 8 further comprising a sequencing device controlling said light emission from said light source.

11. The flame simulation assembly of claim 8 further comprising a rotation disk including apertures positioned substantially near said light source, wherein said rotation disk fragments said light emission from said light source.

12. The flame simulation assembly of claim 8 further comprising a privacy glass, wherein said privacy glass is transparent when electrical current is applied to said privacy glass.

13. The flame simulation assembly of claim 13 wherein said privacy glass is opaque when electrical current is not applied to said privacy glass.

14. A flame simulation assembly comprising:
a housing;
an ember bed panel including refractories; and
a light source positioned substantially beneath said ember bed panel, wherein said light source emits light through said refractories.

15. The flame simulation assembly of claim 15 wherein said light source includes a light emitting diode.

16. The flame simulation assembly of claim 15 further comprising fiber optic cables including a first end and a second end, wherein said first end is positioned substantially near said light source and said second end is positioned substantially near said refractories.

17. The flame simulation assembly of claim 15 further comprising a sequencing device controlling said light emission from said light source.

18. The flame simulation assembly of claim 15 further comprising a rotation disk including apertures positioned substantially near said light source, wherein said rotation disk fragments said light emission from said light source.

19. The flame simulation assembly of claim 15 further comprising a privacy glass, wherein said privacy glass is transparent when electrical current is applied to said privacy glass.

20. The flame simulation assembly of claim 20 wherein said privacy glass is opaque when electrical current is not applied to said privacy glass.

21. A flame simulation assembly comprising:
a housing;
a flame cut-out panel;
a log including an opening;
an ember bed panel including refractories;
a first light source positioned substantially behind said flame cut-out panel, wherein said first light source emits light;
a projection screen positioned substantially in front of said flame cut-out panel, wherein said light is transmitted through said flame cut-out panel onto said projection screen.
a second light source positioned substantially beneath said log, wherein said second light source emits light through said opening; and
a third light source positioned substantially beneath said ember bed panel, wherein said third light source emits light through said refractories.
